(19) United States
(12) Patent Application Publication
(10) Pub. No.: US 2013/0298882 A1
(43) Pub. Date: Nov. 14, 2013

(54) EGR with Temperature Controlled Venturi Flow Meter

(71) Applicants: Joseph John Stabnik, Rensselaer, IN (US); Matthew Edward Leustek, Metamora, IL (US); Matthew John Liening, Washington, IL (US); Jeffrey Scott Morris, Bartonville, IL (US)

(72) Inventors: Joseph John Stabnik, Rensselaer, IN (US); Matthew Edward Leustek, Metamora, IL (US); Matthew John Liening, Washington, IL (US); Jeffrey Scott Morris, Bartonville, IL (US)

(73) Assignee: CATERPILLAR, INC., Peoria, IL (US)

(21) Appl. No.: 13/470,530

(22) Filed: May 14, 2012

(51) Int. Cl. G01F 1/44; F02M 25/07

(52) U.S. Cl. 123/568.11; 73/861.63

(57) ABSTRACT

A flow meter that may be used in an exhaust gas recirculation (EGR) system is disclosed. The EGR system may be part of an internal combustion engine or other power source. The flow meter includes a venturi that includes a body that defines an inlet section, a throat and a diverging outlet section. The flow meter also includes a sensor coupled to the venturi via a plurality of pressure passages.

### TECHNICAL FIELD

This disclosure relates to internal combustion (IC) engines, and, more particularly, to exhaust gas recirculation (EGR) systems for IC engines. Also, this disclosure relates to an improved venturi flow meter that may be used to determine the exhaust gas recirculation rate for EGR systems.

### BACKGROUND

An internal combustion (IC) engine may include an exhaust gas recirculation (EGR) system for controlling the generation of undesirable pollutant gases and particulate matter. EGR systems recirculate the exhaust gas by-products into the intake air supply of the engine. The exhaust gas which is reintroduced to the engine cylinder reduces the concentration of oxygen therein, which lowers the maximum combustion temperature within the cylinder and slows the chemical reaction of the combustion process. This causes a decrease in the formation of nitrous oxides (NOₓ). Furthermore, the exhaust gases typically contain unburned hydrocarbons which are burned on reintroduction into the engine cylinder, which further reduces the emission of undesirable pollutants.

An engine equipped with an EGR system may also include one or more turbochargers for compressing the intake air which is supplied to one or more combustion chambers. Each turbocharger typically includes a turbine driven by exhaust gases of the engine and a compressor which is driven by the turbine. The compressor receives air to be compressed and supplies the compressed air to the combustion chambers.

When utilizing EGR in a turbocharged diesel engine, the exhaust gas to be recirculated may be removed upstream of the turbine. The percentage of the total exhaust flow which is diverted for introduction into the intake manifold of an engine is known as the “EGR rate” of the engine. It may desirable to control the EGR rate within a relatively small tolerance range around a target EGR rate. Venturis may be used as flow meters on engines to measure exhaust gas flow recirculated to the intake manifold. Venturis are useful because they provide a pressure differential across the device which can be correlated to a mass flow rate. Two or more pressure passageways are connected to the venturi, which accommodate pressure probes.

However, conventional venturis used in EGR systems for engines may experience build up or deposition of combustion products on the inside surfaces of the pressure passageways, which can narrow and/or eventually plug the passageways altogether, thereby compromising the accuracy of the pressure differential measurement. Because an accurate measurement of the EGR rate is essential for controlling the emissions of an engine, the problem of combustion product deposition on the inside surfaces of the venturi pressure passageways or total plugging of the venturi pressure passageways must be addressed.

The deposition of combustion products on the inside surfaces of the pressure passageways may be at least partially attributed to thermophoresis. Thermophoresis is a phenomenon observed when particles are subjected to the force of a temperature gradient. Different types of particles respond to temperature gradients differently. Thermophoresis is observed at the scale of one millimeter or less.

Using a venturi flow meter as an example, hot exhaust gases pass through the venturi. Meanwhile, the pressure passageways of the venturi are also exposed to the ambient environment, which is typically cooler than the hot exhaust gases. As a result, the inside surfaces of the pressure passageways are cooled by the ambient atmosphere while the hot exhaust gases pass through the venturi. As the particles in the exhaust gases flow near the cooler inside surfaces of the pressure passageways, the particles experience a cooling effect. The cooled particles may flow towards the inside surfaces of the pressure passageways and accumulate on said inside surfaces. In other words, the particles in the exhaust gases will move in a direction down the temperature gradient or towards the cooler surface. To counter this problem, a convenient way to reduce the temperature gradient between the exhaust gas flow and the inside surfaces of the pressure passageways must be found.

One attempt at solving these problems is disclosed in US2010/0154758, which utilizes a liquid heat exchange chamber or jacket near the throat of the venturi. Liquid coolant is typically circulated through the chamber from the primary coolant system of the engine. The implementation of this design is expensive and space intensive because, in addition to the heat exchange chamber, connections to and from the primary coolant system are required.

What is needed is a more reliable and cost-efficient venturi flow meter design for an EGR system that maintains the inside surfaces of the pressure passageways of the venturi at an appropriately high temperature to limit the effects of thermophoresis and other mechanisms that can lead to soot deposition and/or soot plugging of the pressure passageways.

### SUMMARY OF THE DISCLOSURE

In one aspect, a flow meter is disclosed. The flow meter includes a venturi that includes a body that defines an inlet section, a throat and a diverging outlet section. The flow meter also includes a sensor coupled to the venturi through a plurality of pressure passageways. The flow meter also includes an outer jacket that encloses at least part of the venturi and pressure passageways to define a sealed chamber that surrounds at least part of the venturi and pressure passageways.

In another aspect, an exhaust gas recirculation (EGR) system for an internal combustion engine is disclosed. The internal combustion engine includes an intake manifold and an exhaust manifold. The EGR system includes a flow meter coupled between the exhaust manifold and the intake manifold. The flow meter includes a venturi that includes a body that defines an inlet section fluidly coupled to the exhaust manifold. The venturi further includes an inlet section, a throat and a diverging outlet section that is fluidly coupled to the intake manifold. The flow meter also includes a sensor linked to a plurality of pressure passageways for measuring a pressure drop across the venturi. The flow meter also includes an outer jacket that encloses at least part of the venturi and pressure passageways to define an enclosed chamber that surrounds at least part of the venturi and pressure passageways.

In yet another aspect, an internal combustion engine is disclosed. The engine includes a block defining at least one combustion cylinder. The engine also includes an intake manifold coupled to the at least one combustion cylinder and an exhaust manifold coupled to the at least one combustion cylinder. The engine also includes a flow meter coupled between the exhaust manifold and the intake manifold. The flow meter includes a venturi that includes a body that defines an inlet section that is fluidly coupled to the exhaust manifold, a throat and a diverging outlet section that is fluidly coupled to the intake manifold. The flow meter also includes a pressure sensor that is coupled to the venturi via a plurality of pressure passageways. The flow meter also includes an outer jacket that encloses at least part of the venturi and pressure passageways to define a sealed chamber that surrounds at least part of the venturi and pressure passageways.

In any one or more of the embodiments described above, the sealed chamber contains air, an inert gas, an oil or the sealed chamber may maintain a vacuum.

### BRIEF DESCRIPTION OF THE DRAWINGS

FIG. 1 is a schematic view of an internal combustion engine equipped with an EGR system with a disclosed flow meter.

FIG. 2 is a side plan view of a flow meter fabricated in accordance with this disclosure.

FIG. 3 is a partial enlarged view of the flow meter shown in FIG. 2, particularly illustrating the probe ports and also illustrating an alternative embodiment wherein the outer jacket is filled with oil or another fluid that is heated using a heating element.

### DETAILED DESCRIPTION

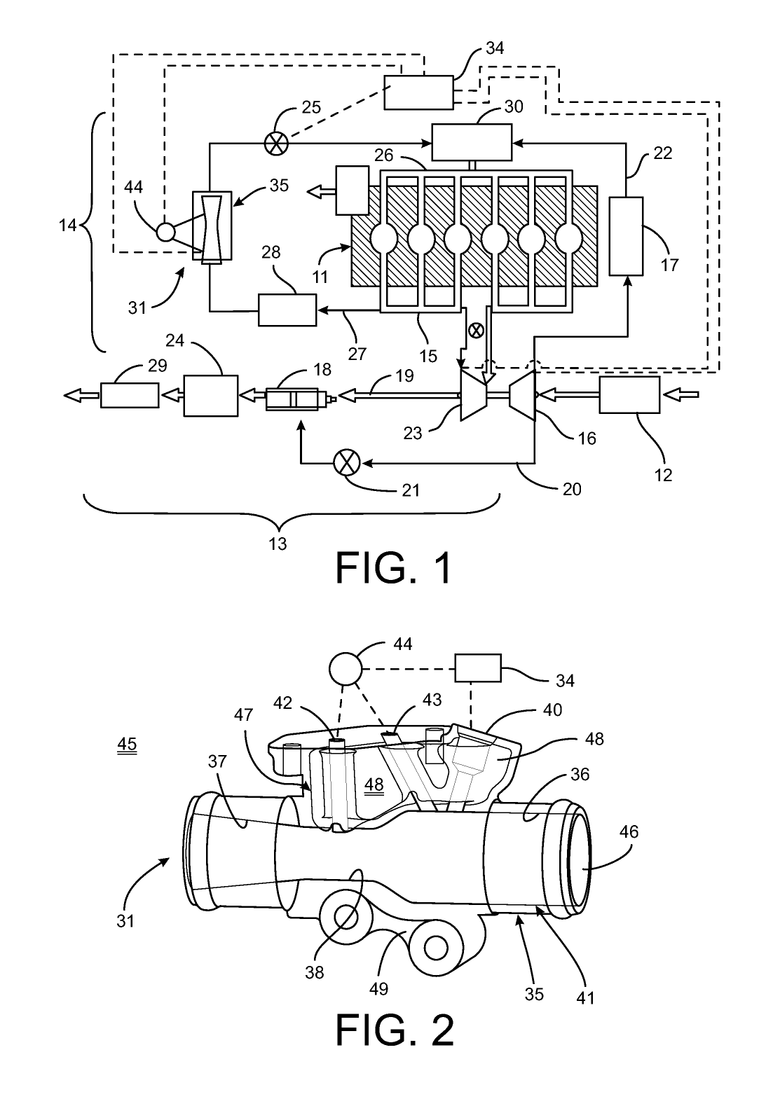

Referring now to FIG. 1, an internal combustion engine or power source 11 is shown that is equipped with an EGR system 14. The engine 11 may be any type of power source, such as a diesel engine, a gasoline engine, a gaseous fuel-powered engine such as a natural gas engine or any other engine apparent to one skilled in the art. The engine 11 may also include in another source of power such as a furnace. The engine 11 may be equipped with an air cleaner or filter 12, an exhaust system 13 and an EGR system 14 coupled to the power source 11 to transfer gases into and out of the engine 11.

The air filter 12 may be coupled to one or more compressors 16 which may be coupled to an air cooler 17 disposed upstream of the engine 11. The compressor(s) 16 may be coupled to a turbine 23, which may part of an exhaust system 13 that may include a discharge line 19, an optional regenerator 18 for elevating the exhaust temperatures in the discharge line 19 before the exhaust gases reach an optional particulate filter 24 to promote oxidation and burning off of soot in the particulate filter 24. A muffler is shown at 29. The exhaust system 13 may include one or more turbines 23 connected in a series relationship, a parallel relationship or only a single turbine 23 may be utilized.

The compressor 16 may be disposed in a series relationship and in communication with the power source 11 via the cooler 17 and mixing system 30. The compressor(s) 16 compresses the air flowing into the power source 11 to a predetermined pressure. The compressor(s) 16 may embody a fixed geometry compressor, a variable geometry compressor or any other type of compressor known in the art. It is contemplated that the compressor(s) 16 may alternatively be disposed in a parallel relationship or that only a single compressor 16 be used. It is further contemplated that the compressor(s) 16 may be omitted, when a non-pressurized air induction system is used. The compressor(s) 16 may also supply the optional regenerator 18 with air via the bypass line 20 and valve 21.

The air cooler 17 may be an air-to-air heat exchanger or an air-to-liquid heat exchanger and may be located to facilitate the transfer of heat to or from the air directed into the mixing system 30 and power source 11. For example, the air cooler 17 may embody a tube and shell type of heat exchanger, a plate type heat exchanger, a tube and fin type heat exchanger or any type of heat exchanger known in the art. The air cooler 17 may be disposed within a passageway 22 that fluidly connects the compressor(s) 16 to the mixing system 30 and power source 11.

Each turbine 23 may be connected to one or more compressors 16 to drive the connected compressor 16. In particular, the hot exhaust gases exiting the power source 11 expand against the blades (not shown) of the turbine(s) 23, causing the turbine(s) 23 to rotate and drive the connected compressor(s) 16. It is also contemplated that the turbine(s) 23 may be omitted and the compressor(s) 16 may be driven by the power source 11 mechanically, hydraulically, electrically or in any other manner known in the art.

Exhaust gases are recirculated from the power source 11, through a portion of the exhaust manifold 15, into the passageway 27, through the cooler 28, the flow meter 31, the EGR valve 25, the mixing system 30 and into intake manifold 26. The EGR valve 25 may be used to control the EGR rate. It is contemplated that the EGR system 14 may also include additional and/or different components, such as a catalyst, an electrostatic precipitation device, a shield gas system or other means for redirecting exhaust from an exhaust system 13 or exhaust manifold 15 to an EGR system 14.

As a portion of the exhaust from the power source 11 enters the EGR system 14 via the exhaust manifold 15, the temperature of the exhaust stream may be reduced to an acceptable level by the exhaust cooler 28. Further, flow through the EGR system 14 may be controlled by the EGR valve 25 disposed downstream of the flow meter 31 and/or a valve (not shown) disposed upstream of the flow meter 31.

As shown in FIG. 1, the EGR valve 25 and flow meter 31 may be linked to a controller 34 which may be an engine control module (ECM) or a separate controller for the EGR system 14. Control of the induction compressor(s) 16, turbine(s) 23 and power source 11 may also be controlled by the controller 34, a separate controller or a separate ECM (not shown).

The exhaust cooler 28 may be disposed within the passageway 27 to cool the portion of the exhaust flowing through the passageway 27. The exhaust cooler 28 may include a liquid-to-air heat exchanger, an air-to-air heat exchanger or any other type of heat exchanger known in the art for cooling exhaust flow. It is contemplated that the exhaust cooler 28 may be omitted, if desired.

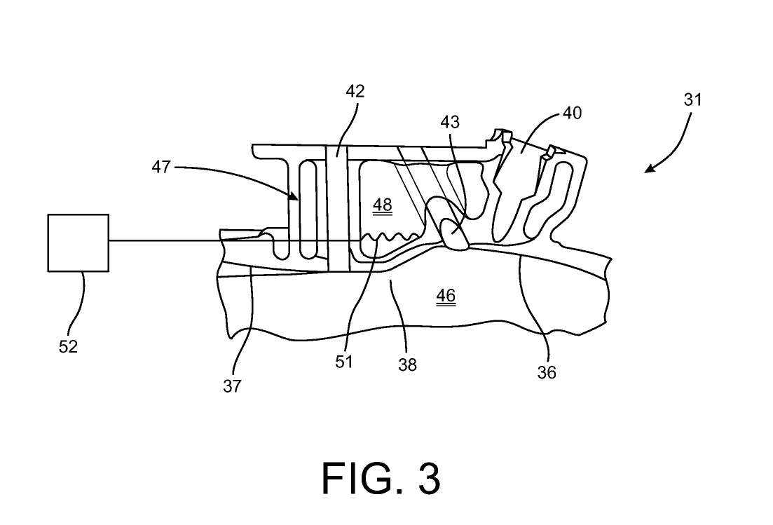

Turning to the flow meter 31 shown in greater detail in FIGS. 2 and 3, the flow meter 31 includes a venturi 35 that includes an inlet section 36, a diverging outlet section 37 and a throat 38. The inlet section 36, throat 38 and diverging outlet section 37 form the venturi body 41. The body 41 includes a first pressure passageway 42 in communication with the throat 38, a second pressure passageway 43 in communication with the inlet section 36 and may have a third passageway 40 for an additional pressure probe (not shown), which may also be linked to the controller 34. The pressure passageways 42, 43 may be coupled to a pressure sensor 44 or multiple pressure sensors (not shown). The pressure sensor 44 and pressure passageway 40 may be in communication with the controller 34.

Because the flow meter 31 is exposed to the ambient environment 45, the pressure passageways 40, 42, 43 of the venturi 35 may accumulate combustion products as the result of thermophoresis, condensation or other mechanisms which can partially or totally plug one or more of the passageways 40, 42, 43. In other words, the gases flowing through the passageway 27, despite being cooled by the optional exhaust cooler 28, are hotter than the ambient environment 45. Thus, the inside surfaces of the pressure passageways 40, 42, 43 are cooler than the exhaust gases flowing through the venturi 35. As a result, particles entrained in the exhaust gas flow will move down the temperature gradient or towards the cooler inside surfaces of the pressure passageways 40. 42, 43. Deposition of these combustion particles along the inside surfaces of the pressure passageways 40, 42, 43 may affect the measurements made by the pressure sensor 44 and compromise the mass flow rates calculated by the controller 34.

To avoid these problems, an outer jacket 47 is disclosed that at least partially surrounds the venturi body 41 as well as the pressure passageways 40, 42, 43. The outer jacket 47 is not for the circulation of coolant or cooling air. Instead, the outer jacket 47 maintains an enclosed or sealed chamber 48 around the pressure passageways 40, 42, 43. Thus, the outer jacket 47 forms a chamber 48 which isolates the pressure passageways 40, 42, 43 from the ambient atmosphere 45, which reduces the cooling effects of the ambient atmosphere 45 and therefore decreases the effects of thermophoresis and the resultant particle or soot deposition on the inside surfaces of the pressure passageways 40, 42, 43. An optional mounting feature is shown at 49.

Finally, as another alternative, the outer jacket 47 may be filled with a fluid, such as oil that may be heated using a heating element 51. The heating element 51 may be a resistive heating element or other suitable heating element and may be powered by a power source 52 such as the battery of the machine (not shown) or other suitable power source.

### INDUSTRIAL APPLICABILITY

Thus, an improved flow meter for an EGR system and/or an internal combustion engine is disclosed. The flow meter is of a venturi-type that may be installed in-line in the exhaust gas recirculation passageway or upstream of the intake manifold or mixing system to the power source or engine. Venturi flow meters have been problematic in the past because the pressure passageways that connect the venturi body to the pressure sensor have been exposed to relatively cold ambient conditions while the interior surfaces of the venturi body are exposed to hot recirculated exhaust gases that include some particulate matter. Due to thermophoresis and other mechanisms, the particles migrate away from the hot exhaust gas stream and towards the inside surfaces of the pressure passageways. The particles may form a coating on the inside surfaces of the pressure passageways which may compromise the pressure readings recorded by the pressure sensor and controller. As a result, a flow meter utilizing a venturi may become inaccurate because the pressure differential measurements across the venturi may be altered by the accumulation of soot and particles on the inside surfaces of the pressure passageways. Therefore, prior art flow meters with pressure passageways having internal surfaces that are coated with soot and particles may no longer accurately correlate a mass flow rate based upon the pressure differential.

To avoid this problem, an improved flow meter is disclosed which also includes a venturi, pressure passageways and a pressure sensor. One pressure passageway is disposed upstream of the throat along the inlet section of the venturi while the other pressure passageway is disposed at the throat. An additional pressure passageway may be disposed along the inlet section of the venturi as well. To avoid the internal surfaces of the pressure passageways from being coated with soot and particles, an outer jacket is formed that provides a sealed enclosure for the pressure passageways and a portion of the venturi. The outer jacket defines a sealed or enclosed chamber that surrounds the pressure passageways. The chamber may be filled with air, an inert gas or the chamber may include little or no gas, i.e. a vacuum. The sealed chamber insulates the pressure passageways from the ambient conditions, thereby minimizing the adverse effects of thermophoresis.

The sealed chamber may also be filled with a fluid that may be heated using a heating element, such as a resistive heating element. A possible fluid would be an oil.

The improved flow meter may be original equipment for an internal combustion engine or may be used to replace an existing flow meter of an EGR system. The flow meter may also have applications beyond internal combustion engines where it is advantageous to maintain the temperature of the venturi body as close as possible to the temperature of the fluid stream flowing through the venturi body.

What is claimed is:

1. A flow meter comprising:
a venturi including a body defining an inlet section, a throat, and a diverging outlet section;
a sensor coupled to the venturi through a plurality of pressure passageways; and
an outer jacket that encloses the plurality of pressure passageways and provides a sealed chamber that at least partially surrounds the plurality of pressure passageways.

2. The flow meter of claim 1 wherein the sealed chamber contains a gas selected from the group consisting of air, at least one inert gas and combinations thereof.

3. The flow meter of claim 1 wherein the sealed chamber contains an oil and wherein the sealed chamber is coupled to a heating element for heating the oil.

4. The flow meter of claim 1 wherein the sealed chamber provides a vacuum.

5. The flow meter of claim 1 wherein the sealed chamber at least partially surrounds the body of the venturi.

6. The flow meter of claim 1 wherein the plurality of pressure passageways include a first pressure passageway connected to the throat.

7. The flow meter of claim 1 wherein the plurality of pressure passageways include a second pressure passageway that is connected to the inlet section.

8. The flow meter of claim 7 wherein the plurality of pressure passageways may include a third additional pressure passageway connected to the inlet section.

9. An exhaust gas recirculation (EGR) system for an internal combustion engine, the internal combustion engine including an intake manifold and an exhaust manifold, the EGR system comprising:
a flow meter coupled between the exhaust manifold and the intake manifold, the flow meter including
a venturi including a body defining an inlet section coupled to the exhaust manifold, the body of the venturi further includes a throat and a diverging outlet section coupled to the intake manifold,
a plurality of pressure passageways that connect the body to a pressure sensor, and
an outer jacket that at least partially surrounds the plurality of pressure passageways and defines a sealed chamber.

10. The EGR system of claim 9 wherein the sealed chamber contains a gas selected from the group consisting of air, at least one inert gas and combinations thereof.

11. The EGR system of claim 9 wherein the sealed chamber contains an oil and wherein the sealed chamber is coupled to a heating element for heating the oil.

12. The EGR system of claim 9 wherein the sealed chamber provides a vacuum.

13. The EGR system of claim 9 wherein the plurality of pressure passageways include a first pressure passageway connected to the throat.

14. The EGR system of claim 9 wherein the plurality of pressure passageways include a second pressure passageway connected to the inlet section.

15. The EGR system of claim 9 wherein the plurality of pressure passageways may include a third additional pressure passageway connected to the inlet section.

16. An internal combustion engine, comprising:
a block defining at least one combustion cylinder;
an intake manifold coupled with the at least one combustion cylinder;
an exhaust manifold coupled to the at least one combustion cylinder;
a flow meter coupled between the exhaust manifold and the intake manifold, the flow meter including a venturi including a body defining an inlet section coupled with the exhaust manifold, a throat, and a diverging outlet section coupled to the intake manifold, the flow meter also including a plurality of pressure passageways that connect the body to a pressure sensor, the flow meter also including an outer jacket that encloses the plurality of pressure passageways and defines a sealed chamber.

17. The engine of claim 16 wherein the sealed chamber contains a gas selected from the group consisting of air, at least one inert gas and combinations thereof.

18. The engine of claim 16 wherein the sealed chamber provides a vacuum.

19. The engine of claim 16 wherein the sealed chamber contains oil and wherein the sealed chamber is coupled to a heating element for heating the oil.

20. The engine of claim 16 wherein the plurality of pressure passageways includes a first passageway connected to the throat.

21. The engine of claim 20 wherein the plurality of pressure passageways includes a second passageway in communication with the inlet section.

22. The engine of claim 21 wherein the plurality of pressure passageways may include a third additional pressure passageway connected to the inlet section.
